(19) United States
(12) Patent Application Publication
(10) Pub. No.: US 2010/0024670 A1
(43) Pub. Date: Feb. 4, 2010

(54) PRINTING APPARATUS AND POSITION ERROR SUPPRESSING METHOD FOR THE PRINTING APPARATUS

(75) Inventors: Katsuhiko Takeda, Hiroshima-ken (JP); Hitoshi Isono, Hiroshima-ken (JP); Keiji Mizuta, Hiroshima-ken (JP); Yoshinori Nakaya, Hiroshima-ken (JP); Shunsuke Kubo, Hiroshima-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 12/515,637

(22) PCT Filed: Feb. 6, 2007
(86) PCT No.: PCT/JP2007/052006

§ 371 Date: May 20, 2009

(30) Foreign Application Priority Data
Nov. 21, 2006 (JP) 2006-314862

(51) Int. Cl. B41F 1/06; B41F 1/34

(52) U.S. Cl. 101/316; 101/485

(57) ABSTRACT

An object is to provide a printing apparatus or the like that improves printing accuracy when a carriage moves back and forth for printing. A block 51 on a block surface plate is mounted on the block surface plate at a predetermined location. On the other hand, a substrate 54 on a print surface plate is mounted at a location corresponding to the location of the block 51, that is, a location where a picture transfer is desirably received from a blanket cylinder 13. In the present invention, the arrangement of sliders 52 and 40 for the block carriage 50 and a printing carriage 7 to reciprocate along two rails 30 in the block carriage 50 and that in the printing carriage 7 are the same. With such an arrangement, at the same location immediately below the blanket cylinder 13 on the same track 30, even when the straightness of the rail 30 is not sufficient, the block 51 and the glass substrate 54 take the same position at the location, and thus print misalignment can be prevented.

### TECHNICAL FIELD

The present invention relates to a printing apparatus and a position error suppressing method for the printing apparatus, and, more particularly to a printing apparatus and a position error suppressing method for the printing apparatus relating to so-called precision printing in which a filter pattern or the like used for liquid crystal display is formed by printing.

### BACKGROUND ART

As one technique of forming a pattern of flat-panel display, such as liquid crystal display (LCD), plasma display (PDP), or electro luminescence (EL) display, on a flat glass substrate or a ceramic substrate, there have been proposed various printing systems.

In Patent Document 1, an offset printing method of a color filter used for liquid crystal display is disclosed. The Patent Document 1 describes a printing apparatus including a block carriage that transports a plurality of blocks arranged in a transportation direction, a blanket cylinder in which a plurality of blankets corresponding to each block are arranged in a circumferential direction, and a printing carriage that transports a glass substrate. This printing apparatus is configured such that the block carriage that moves on a rail is moved below the blanket cylinder and a picture of each block is sequentially transitioned to each blanket that is arranged in a circumferential direction of the blanket cylinder.

When a picture is transferred to a glass substrate from a blanket cylinder, the printing carriage moves below the blanket cylinder on the rail, and while advancing in parallel therewith responding to a rotation of the blanket cylinder, the printing carriage receives the picture from the blanket. Thereafter, the printing carriage is returned back to a transfer starting location again, and while similarly advancing in parallel, the printing carriage receives the picture from the subsequent blanket. In this way, to receive the picture from each blanket, the printing carriage is configured to reciprocate as many times as the number of blocks.

Patent Document 1: Japanese Patent Application Laid-open No. H5-169626

### DISCLOSURE OF INVENTION

### Problem to be Solved by the Invention

However, in the configuration of the conventional technique, when the straightness of the rails for moving the blocks and the substrate is insufficient, each carriage cannot take a desired position at a transfer location, resulting in causing print misalignment. It is not easy to maintain the straightness of the rail throughout the length of several meters. Moreover, the carriage is deformed due to a driving force or heat generated by a driving unit, and a location and a position of the blocks or the substrate mounted thereon are changed, which also results in causing print misalignment.

The present invention has been achieved in view of the above circumstances, and an object of the invention is to provide a printing apparatus in which a carriage carried thereon with a block or a substrate is so configured that it is hardly affected by an error source element that adversely affects the position at the time of moving back and forth, whereby printing accuracy is improved, and also to provide a position error suppressing method for the printing apparatus.

### Means for Solving Problem

According to an aspect of the present invention, a printing apparatus includes: a block carriage that supports a block surface plate having a block mounted thereon at a predetermined location and is reciprocated on a track by a first driving unit via a first track guiding member; a printing carriage that supports a print surface plate having a substrate mounted thereon at a predetermined location and is reciprocated by a second driving unit via a second track guiding member on a same track as the track on which the block carriage is reciprocated; a blanket cylinder that is pivotally supported to rotate at a predetermined location and on which a resin transition between the blanket cylinder and the block on the block carriage and a picture transfer between the blanket cylinder and the substrate on the printing carriage are alternately performed; and a coating unit that applies a predetermined resin on a surface of the blanket cylinder. the first track guiding member and the second track guiding member are located in the block carriage and the printing carriage, respectively, to establish a same location relation, whereby the block and the substrate exchange the resin applied to the blanket cylinder at a same location on the track.

A block on a block surface plate is mounted at a predetermined location on the block surface plate. On the other hand, a picture (that is formed by removing by a concave portion of a block an unnecessary portion of ink coated on a surface of a blanket cylinder) to which a resin is transitioned from the block is transferred from a blanket cylinder to a substrate on a print surface plate, and thus the substrate is mounted at a location corresponding to the location of the block, that is, a predetermined location where a picture transfer is desirably received from the blanket cylinder on the print surface plate.

When there is established the same location relation between the arrangement of a track guiding member of a block carriage and the arrangement of a track guiding member of a printing carriage, even when the straightness of the track is not sufficient, a contact state between the track and the track guiding member is the same at the same location on the same track. Accordingly, the block carriage and the printing carriage take the same position, and thus the block on each carriage and the substrate also take the same position. As a result, the resin transition from the blanket cylinder to the block matches the picture transfer of the resin left by the resin transition from the blanket cylinder to the substrate without being affected by a track error.

Advantageously, in the printing apparatus, the blanket cylinder is pivotally supported to rotate at a fixed location.

When the blanket cylinder is located at a fixed location, a location error and a position error caused by the movement of the blanket cylinder do not affect the printing. When the block carriage and the printing carriage are reciprocated and the resin transition and the picture transfer are performed at the same location immediately below the blanket cylinder, even if there is an error in the straightness of the track, print misalignment can be prevented without being affected by the error.

Advantageously, in the printing apparatus, the block carriage is combined by a combining unit to a conveyance carriage that is reciprocated by the first driving unit, so that the block surface plate is transported reciprocably in a certain direction.

The block carriage is reciprocated by a first driving unit as a driving source. Examples of the first driving unit include a rack-and-pinion, a ball screw and a nut, while examples of non-contact type include a linear motor. With using any means, a force is imparted to a drive target, and if the drive target is directly a block carriage, the block carriage is slightly deformed. When the driving unit is the linear motor, a motor coil portion located at the bottom of a carriage is generally suctioned by a suction force of a magnet laid in a track direction. As a result, distortion is generated.

In the present invention, by the first driving unit, instead of the block carriage, the conveyance carriage having the block carriage carried thereon receives a force. The block carriage is combined to the conveyance carriage by a combining unit such as a rod stock. Accordingly, the block carriage is not affected by the position error resulting from a slight deformation by the driving unit.

Advantageously, in the printing apparatus, the printing carriage is combined by a combining unit to a conveyance carriage that is reciprocated by the second driving unit, so that the print surface plate is transported reciprocably in a certain direction.

Similarly to the block carriage, the printing carriage is also reciprocated by a driving unit as a driving source. In the present invention, by the second driving unit, instead of the printing carriage, the conveyance carriage receives the force. The printing carriage is combined to the conveyance carriage by the combining unit such as a rod stock. Accordingly, the printing carriage is not affected by the position error resulting from a slight deformation by the driving unit.

According to another aspect of the present invention, a printing apparatus includes a block carriage that supports a block surface plate having a block mounted thereon at a predetermined location and is combined by a combining unit to a conveyance carriage that is reciprocated on a track by a driving unit.

In the present invention, by the driving unit, instead of the block carriage, the conveyance carriage receives the force. The block carriage is combined to the conveyance carriage by the combining unit such as a rod stock. Accordingly, the block carriage is not affected by the position error resulting from a slight deformation by the driving unit.

In the printing apparatus according to the present invention, there is included a block carriage that supports a print surface plate having a substrate mounted thereon at a predetermined location and that is combined by a combining unit to a conveyance carriage that is reciprocated on a track by a driving unit.

In the present invention, similarly to the invention described above, by the driving unit, instead of the printing carriage, the conveyance carriage receives the force. The printing carriage is combined to the conveyance carriage by the combining unit such as a rod stock. Accordingly, the printing carriage is not affected by the position error resulting from a slight deformation by the driving unit.

Advantageously, in the printing apparatus, the block carriage or the printing carriage, and the conveyance carriage are combined by a combining unit in which a rigidity in a certain direction is larger than a rigidity of the track guiding members and a rigidity in other directions is smaller than the rigidity of the track guiding members.

In the present invention, by the driving unit, instead of the block carriage or the printing carriage, the conveyance carriage receives the force. The block carriage or the printing apparatus is combined to the conveyance carriage by a combining unit in which a rigidity in a reciprocating transportation direction is larger than a rigidity of the track guiding members and a rigidity in other directions is smaller than the rigidity of the track guiding members, only the traction in the transportation direction is transmitted and the force in other directions is not transmitted to the block carriage itself because the combining unit is deformed. Accordingly, the block carriage or the printing carriage is not affected by the position error resulting from a slight deformation by the driving unit.

Also, the printing apparatus according to the present invention is configured such that in the printing apparatus, the combining unit is a rod-shaped member of which a center portion relative to the transportation direction is thinned at least in the horizontal direction.

When the block carriage or the printing carriage is combined to the conveyance carriage by using a member of which the center portion relative to the transported direction is thinned as a combining member, the rigidity in the reciprocating transportation direction can be increased more than the rigidity in other directions expect for this direction. Moreover, the rigidity in the transportation direction can be increased more than the rigidity of the track guiding member used for transporting the carriage. Accordingly, only the traction in the transportation direction is transmitted to the carriage while a motion (force) by the track error in other directions is absorbed by the thinned portion and is not transmitted to the carriage.

Advantageously, in the printing apparatus, the conveyance carriage reciprocates via a third track guiding member on a same track as the track on which the block carriage or the printing carriage reciprocates.

When a total of four tracks, that is, two tracks used for the reciprocation of the block carriage and the printing carriage and two tracks used for the reciprocation of the conveyance carriage are arranged, time and labor are required for adjusting the straightness of each track and the parallelism to the tracks with each another. On the contrary, when the track for the conveyance carriage is rendered the same as that for the block carriage or the printing carriage, the adjustment of the straightness and the parallelism is necessary only for the two tracks. Thus, the time and labor are reduced in half.

Advantageously, in the printing apparatus, the block carriage is arranged in plural to correspond to number of the blocks that become necessary for printing, and the plurality of block carriages are combined to one conveyance carriage and reciprocate in a certain direction.

When a plurality of conveyance carriages are each combined to one conveyance carriage, there is no need to prepare a plurality of driving units. Accordingly, complicated synchronization control or interference preventive control becomes unnecessary, and thus simplification can be achieved. There is also an advantage that the printing apparatus can be established economically. Furthermore, the position errors in the reciprocation are averaged, and thus the moving accuracy as well as the printing accuracy are improved. Further, because the mass of the conveyance carriage is increased, the effect of suppressing vibration is also improved.

Advantageously, in the printing apparatus, the block carriage and the printing carriage are combined to the conveyance carriage in common and reciprocate in a certain direction.

When the block carriage and the printing carriage are combined to the common conveyance carriage and are reciprocated in the certain direction, it is not necessary any more to arrange the conveyance carriage for each carriage. Thus, the number of driving units can be reduced and complicated synchronization control or interference preventive control becomes unnecessary, and hence the control becomes simple. Further, the weight can be generally reduced, and thus power saving and resource saving can be made.

Advantageously, in the printing apparatus, the first driving unit and the second driving unit are linear motors.

When the driving unit is a linear motor, the driving unit can be driven in a non-contact manner, and thus, as compared to a contact-type driving unit, it is possible to reduce the moving error or the position error at the time of reciprocation. Further, there is no backlash that is specific to the contact-type driving unit. In addition, the acceleration in the reciprocation is several times higher as compared to the contact-type such as a ball screw, and this results in reduction of a printing time.

In the printing apparatus according to the present invention, in the printing apparatus mentioned above, a connecting portion between the first driving unit and the conveyance carriage is located in the transportation direction of the conveyance carriage more externally of the combining portion at the extreme end on the conveyance carriage.

The driving unit is provided on the conveyance carriage. The driving unit, either of a contact type or a non-contact type, has a property of generating heat. This heat induces thermal expansion around the location where the conveyance carriage is provided. To avoid this, out of the combining portion between the block carriage or the like and the conveyance carriage, a combining portion at the extreme end is located to be spaced apart from the thermally expanded portion, and thus the influence of the thermal expansion is received only at the ends. Accordingly, it is possible to avoid a situation that only a certain portion among the combining portions is affected by the thermal expansion, and thus a distance between each carriage becomes constant, and hence it is advantageous for the location control of the carriage.

According to still another aspect of the present invention, a position error suppressing method for a printing apparatus includes: applying a predetermined resin by a coating unit on a surface of a blanket cylinder pivotally supported to rotate at a predetermined location on a mount; causing a block carriage that is reciprocated by a first driving unit to move on a track via a first track guiding member to immediately below the blanket cylinder to bring a block supported at a predetermined location on a block surface plate on the block carriage into contact with the blanket cylinder, whereby a resin on the surface of the blanket cylinder is transitioned to the block; after retracting the block carriage from immediately below the blanket cylinder on the track, causing a printing carriage that is reciprocated by a second driving unit via a second track guiding member, which is disposed to have a same positional relation as the first track guiding member, on the track to move to immediately below the blanket cylinder at a same location as that where the resin is transitioned to the block to bring a substrate that is supported at a predetermined location on a print surface plate on the printing carriage into contact with the blanket cylinder, whereby the resin left on the surface of the blanket cylinder is transferred in picture to the substrate.

According to still another aspect of the present invention, a position error suppressing method for a printing apparatus includes: applying a predetermined resin by a coating unit on a surface of a blanket cylinder pivotally supported to rotate at a predetermined location on a mount; causing a block carriage that is reciprocated by a first driving unit to move on a track via a first track guiding member to immediately below the blanket cylinder to bring a block supported at a predetermined location on a block surface plate on the block carriage into contact with the blanket cylinder, whereby a resin on the surface of the blanket cylinder is transitioned to the block; after retracting the block carriage from immediately below the blanket cylinder on the track, causing a printing carriage that is reciprocated by a second driving unit via a second track guiding member on the track to move to immediately below the blanket cylinder at a same location as that where the resin is transitioned to the block to bring a substrate that is supported at a predetermined location on a print surface plate on the printing carriage into contact with the blanket cylinder, whereby the resin left on the surface of the blanket cylinder is transferred in picture to the substrate. The driving unit of at least one of the block carriage or the printing carriage is attached to the conveyance carriage reciprocating on the track, and the conveyance carriage and the block carriage, or the conveyance carriage and the printing carriage, are combined by a combining unit.

### EFFECT OF THE INVENTION

In the printing apparatus and the position error suppressing method for the printing apparatus according to the present invention, between the carriage having a block carried thereon and the carriage a substrate carried thereon, the respective positions for a resin transition and for a picture transfer at the same location become the same. Thus, it is possible to suppress the position error, and the printing accuracy is improved. Further, because a configuration that is hardly affected by an error element that adversely affects the position accuracy when the carriage moves back and forth is adopted, the printing accuracy can be improved.

### BRIEF DESCRIPTION OF DRAWINGS

FIG. 1 is a front view of a printing apparatus according to a first embodiment of the present invention.

FIG. 2 is an explanatory diagram of a track of a printing carriage.

FIG. 3 is a perspective view of a configuration around the printing carriage.

FIG. 4 is a cross-sectional view of an A-A cross-section of FIG. 3.

FIG. 5 is a top view of an arrangement of a track guiding member according to the present invention.

FIG. 6 is a top view of a configuration of a printing apparatus according to a second embodiment of the present invention.

FIG. 7 is a front view of a configuration of the printing apparatus according to the second embodiment of the present invention.

FIG. 8 is a cross-sectional view of a B-B cross-section of FIG. 6.

FIG. 9 is a perspective view of an appearance of a combining unit.

FIG. 10 is a top view of a first modification of the printing apparatus according to the second embodiment of the present invention.

FIG. 11 is a front view of the first modification of the printing apparatus according to the second embodiment of the present invention.

FIG. 12 is a top view of a second modification of the printing apparatus according to the second embodiment of the present invention.

FIG. 13 is a front view of the second modification of the printing apparatus according to the second embodiment of the present invention.

FIG. 14 is a cross-sectional view of a C-C cross-section of FIG. 12.

FIG. 15 is a top view of a third modification of the printing apparatus according to the second embodiment of the present invention.

FIG. 16 is a front view of the third modification of the printing apparatus according to the second embodiment of the present invention.

FIG. 17 is a top view of a fourth modification of the printing apparatus according to the second embodiment of the present invention.

FIG. 18 is a front view of the fourth modification of the printing apparatus according to the second embodiment of the present invention.

FIG. 19 is a cross-sectional view of a D-D cross-section of FIG. 17.

FIG. 20 is a perspective view of an appearance of a combining unit.

FIG. 21 is a top view of a fifth modification of the printing apparatus according to the second embodiment of the present invention.

FIG. 22 is a front view of the fifth modification of the printing apparatus according to the second embodiment of the present invention.

FIG. 23 is a cross-sectional view of an E-E cross-section of FIG. 21.

FIG. 24 is a front view of an example where a driving unit is configured as a ball screw and a nut.

FIG. 25 is a top view of an example when there are three rails.

1 printing apparatus
2a, 2b, 2c, 2d block
3 mount
4 glass substrate
30, 63, 83, 90 rail
5, 50 block carriage
6a, 6b, 6c, 6d coating device
7 printing carriage
9a, 9b, 9c, 9d block surface plate
11 print surface plate
13a, 13b, 13c, 13d blanket cylinder
32 recess
34 magnet
36 linear scale
40, 62, 52, 79 slider
42 linear motor
44 linear sensor
51 block
54 glass substrate
60, 65, 70, 71, 78 conveyance carriage
61, 75, 76, 77 combining unit

### BEST MODE(S) FOR CARRYING OUT THE INVENTION

Exemplary embodiments of a printing apparatus and a position error suppressing method for the printing apparatus according to the present invention will be explained below in detail with reference to the accompanying drawings. The present invention is not limited to the embodiments.

### First Embodiment

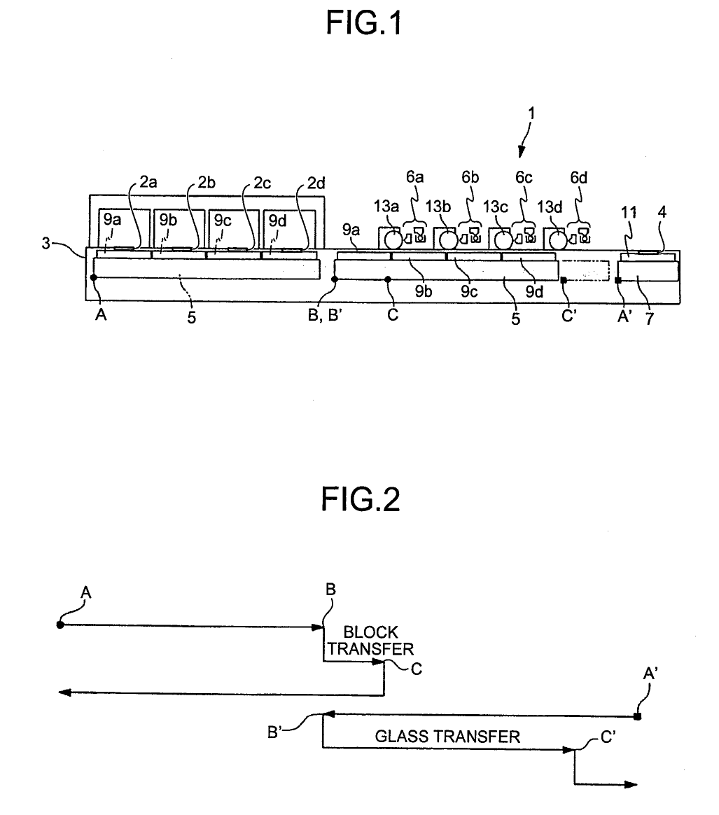

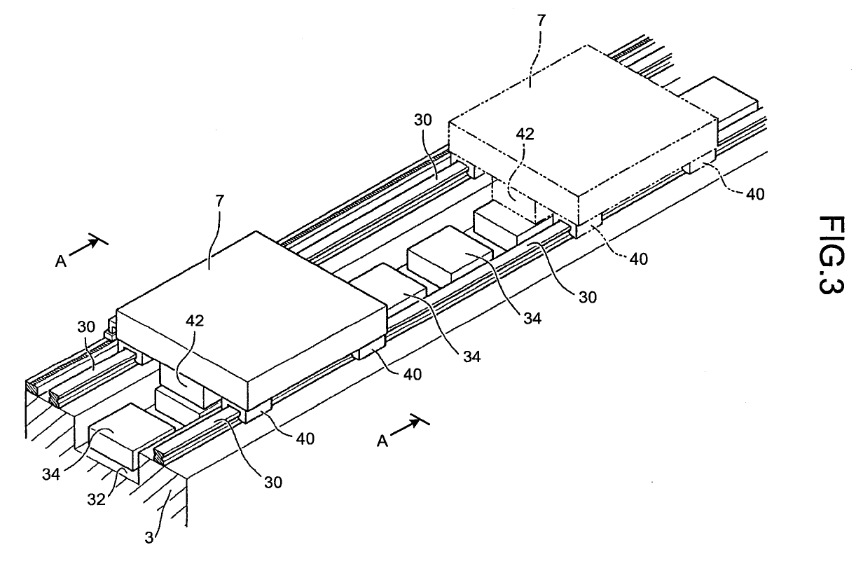

FIG. 1 is a front view of a printing apparatus according to a first embodiment of the present invention. FIG. 2 is an explanatory diagram of a track of each carriage. In this case, a flat-bed printing apparatus that prints a color filter of liquid crystal display is used as an example. A printing apparatus 1 includes a block carriage 5 that transports a plurality of block surface plates 9a to 9d and a printing carriage 7 that transports a glass surface plate 11. By a first driving unit and a second driving unit, which are described later, the block carriage 5 and the printing carriage 7 are reciprocated in a certain direction (in a longitudinal direction in FIG. 1) on a mount 3.

A block surface plate 9 has blocks 2a to 2d mounted thereon at each predetermined location, where a marker, a patch, a groove, and other jigs are used as a reference. The glass surface plate 11 has a glass substrate 4 as a substrate mounted thereon at a predetermined location, where a jig or the like are used as a reference. At predetermined locations crossing over a rail 30 described later at the substantial center of the printing apparatus 1, four blanket cylinders 13a to 13d are arranged in a line along a printing direction (transportation direction). Each blanket cylinder 13a to 13d is pivotally supported to rotate freely. Moreover, in each blanket cylinder 13a to 13d, coating devices 6a to 6d are annexed as coating units so that predetermined resin is applied onto a surface of each blanket cylinder 13a to 13d.

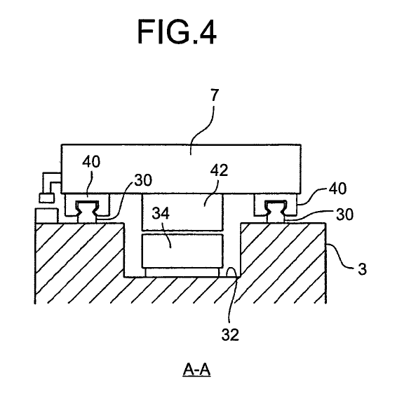

FIG. 3 is a perspective view of a configuration around a printing carriage. FIG. 4 is a cross-sectional view of an A-A cross-section of FIG. 3. However, the same configuration is used for the block carriage 5, and hence explanations of the configuration of the block carriage 5 will be omitted. As shown in FIG. 3, two rails (tracks) 30 are arranged in the mount 3 along the longitudinal direction (printing direction) of the mount 3. A recess 32 is formed toward the printing direction at the center of the mount 3 located between the rails 30 (see FIG. 4), and a plurality of magnets 34 are set up in this recess 32. Each magnet 34 is a permanent magnet, for example, and is arranged in the printing direction so that opposite magnetic fields are alternately provided.

A slider 40 is arranged below the printing carriage 7 as a track guiding member to slide or roll on the rail 30. In the center of the bottom surface of the printing carriage 7, a linear motor 42 is attached as a second driving unit. The linear motor 42 forms an alternating magnetic field by a controller (not shown), and provides the driving force in the printing direction by using gravitational force and repulsive force formed between the linear motor 42 and the magnet 34 fixed on the mount 3 side. In this case, although an example in which the linear motor is adopted is depicted, the driving unit is not limited thereto, and a general driving unit such as a rack-and-pinion, a ball screw and a nut, can also be used. For the sake of explanation, a driving unit that drives the block carriage 5 is a first driving unit while a driving unit that drives the printing carriage 7 is a second driving unit.

A printing step is described here. First, as shown in FIG. 1, the resin is applied from each coating device 6a to 6d to the surface of each blanket cylinder 13a to 13d so that the applied resin achieves a predetermined uniform film thickness. Next, below these blanket cylinders 13, the block surface plate 9 and the glass surface plate 11 pass through. Specifically, the block carriage 5 is moved by the first driving unit so that a reference point A of the block surface plates 9a to 9d reaches the location of a reference point B. Upon moving therefrom to a reference point C, the blocks 2a to 2d come in contact with the blanket cylinders 13a to 13d. Out of each resin on the surface of the blanket cylinders 13a to 13d, only non-printing part is transitioned to each block 2a to 2d, and as a result, the resin remains only in a picture portion. After retracting the block carriage 5 to the original location, the printing carriage 7 is moved by the second driving unit so that a reference point A′ of the glass surface plate 11 reaches a location of a reference point B′. Upon moving therefrom to a reference point C′, the glass substrate 4 comes in contact with each blanket cylinder 13a, 13b, 13c, and 13d. The picture is transferred from the blanket cylinders 13a, 13b, 13c, and 13d to the glass substrate 4.

The blanket cylinder 13 alternately performs a resin transition between the blanket cylinder 13 and the reciprocating block and a picture transfer between the same and the reciprocating glass substrate. In other words, the blanket cylinder 13 is arranged at a fixed location common to a trajectory of the reciprocation of the block surface plate 9 having a block mounted thereon and a trajectory of the reciprocation of the glass surface plate 11 has a glass substrate as a substrate. That is, when each blanket cylinder is focused one by one, the resin transition by the block and the picture transfer to the glass substrate are performed at the same point (location) on the same track. In the present embodiment, the example in which the blanket cylinder is fixed at the fixed location is described. However, even when a system in which the blanket cylinder is moved is adopted, it suffices as long as the resin transition by the block and the picture transfer to the glass substrate are exchanged at the same point on the same track.

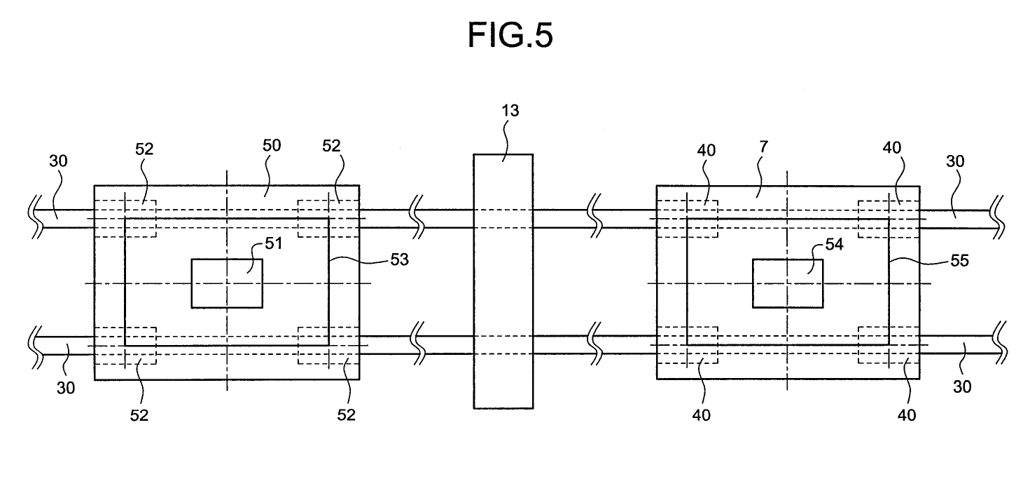

FIG. 5 is a top view of the arrangement of the track guiding member of the printing apparatus according to the present invention. The present invention is characterized such that sliders 52 and 40 for a block carriage 50 and the printing carriage 7 to reciprocate along two rails 30 are fixed firmly in a manner to have the same dimension and arrangement as the block carriage 50 and the printing carriage 7. When the resin transition by the block and the picture transfer to the glass substrate are performed on the same point on the same track by using the block carriage 50 and the printing carriage 7 thus configured, even when the straightness is not sufficiently secured on the track, location misalignment and position misalignment of the both carriages are the same. Thus, the consistency of the picture arrangement onto a block 51 on the block carriage 50 and a glass substrate 54 on the printing carriage 7 is secured. That is, it is possible to print at the same position and location without being effected by the straightness error of the rail 30, and thus the printing accuracy and the printing quality can be improved.

For example, when a square 53 formed by linking the centers of the sliders 52 of the block carriage 50 and a square 55 formed by linking the centers of the sliders 40 of the printing carriage 7 are the same in size, shape, and arrangement, even when the straightness of the rail 30 immediately below the blanket cylinder 13 set up at a fixed location in a manner to cross over the rail 30 in FIG. 5 is poor, and thus the position of each carriage 50 and 7 is slant at that location, the slant of both the carriages 50 and 7 remains identical, hence the position error is suppressed, and the resin transition by the block 51 and the picture transfer to the glass substrate 54 can be performed without any misalignment. While it is preferable that the sliders 52 and 40 are made by completely identical parts or parts of the same specifications, these sliders can be members having motion straightness in a certain range corresponding to the accuracy required for the printing.

To have the motion straightness in a certain range corresponding to the accuracy required for the printing means to have straightness to the extent that a relative location between a block carriage and a printing carriage does not exceed the accuracy permitted for printing (which can be exceeded resulting from the error itself when the motion straightness over a certain distance as specifications for a track guiding member is poor). Specifically, for the straightness of the track guiding member, when a general track guiding member that is distributed in the market is used, there will be no problem. For example, Linear Roller Way LRX40SP manufactured by Nippon Thompson Co., Ltd. is used while slight pressure is applied, there will be no gutter and it will smoothly act directly on the accuracy required for the present precision printing, with sufficient motion straightness.

An attachment error in the permissible track guiding member can be evaluated from a geometrical relation if a case that the location of each track guiding member that is attached to each carriage is appropriately misaligned is considered. Thus, the error can be appropriately determined by taking the permissible accuracy for the printing into consideration. For example, when printing accuracy of ±3 micrometers is required, if the attachment error is about 10 millimeters for a 400-mm attachment span of the track guiding member, this error is permissible.

Besides, the sliders 52 and 40 are generally located at a so-called Bessel point in strength of materials to average distortions caused by the self-load of the carriages. However, in the printing apparatus, the block 51 and the glass substrate 54 are used in special conditions (specifications) in which the block 51 and the glass substrate 54 are sunk under the blanket cylinder 13 while receiving the pressure of the blanket cylinder 13. A test was conducted for this, and as a result it was found out as shown in FIG. 5 that locating the sliders 52 and 40 at the ends of the transportation direction was effective in suppressing the deformations of the block carriage 50 and the printing carriage 7 as well as the position change of the block carriage 50. It was also found out that a transportation direction and a perpendicular direction should be located at a general Bessel point.

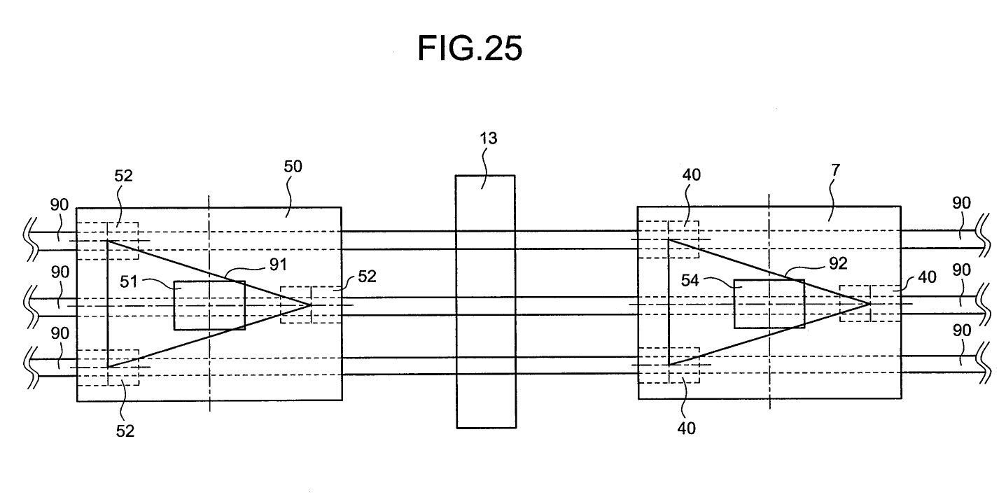

FIG. 25 is a top view of an example when there are three rails. Geometrically, it suffices that three points are determined to decide a plane surface. Thus, to make constant plane surfaces of the block carriage 50 and the printing carriage 7 on which the block 51 and the glass substrate 54 are mounted, it is also possible to consider a case that three sliders 52 and 40 each are arranged for three rails 90. Even in this case, the sliders 52 and 40 for the block carriage 50 and the printing carriage 7 to reciprocate along the three rails 90 are allowed to have the motion straightness in a certain range, and the slider 52 of the block carriage 50 and the slider 40 of the printing carriage 7 are placed the same. With this configuration, it suffices that the resin transition and the picture transfer are performed at the same location immediately below the blanket cylinder 13.

In this way, the resin transition by the block and the picture transfer to the glass substrate performed immediately below the blanket cylinder 13 are exchanged at the same point on the same track 90. As a result, the block 51 and the glass substrate 54 become able to hold the same position at the location even if there is an error in the straightness or parallelism of the rail 90. Accordingly, the error in the track does not affect the resin transition from the block 51 to the blanket cylinder 13 and the picture transfer from the blanket cylinder 13 to the glass substrate 54. As a result, according to the printing apparatus, the position error caused when the carriage carried thereon with the block or the glass substrate moves back and forth is suppressed, and the printing accuracy can be improved.

### Second Embodiment

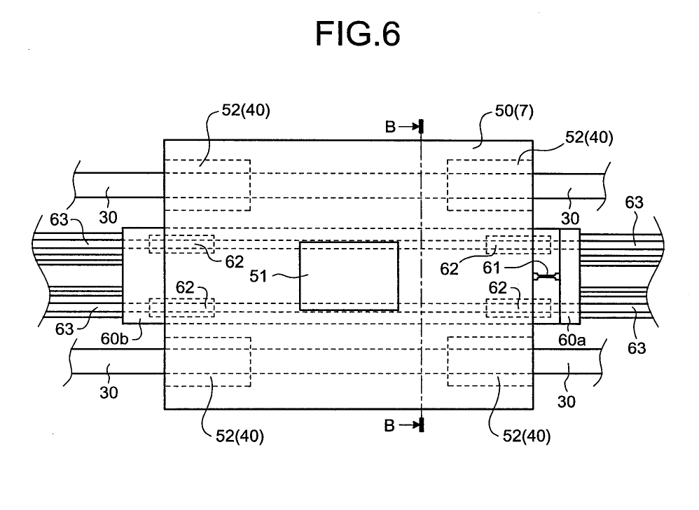

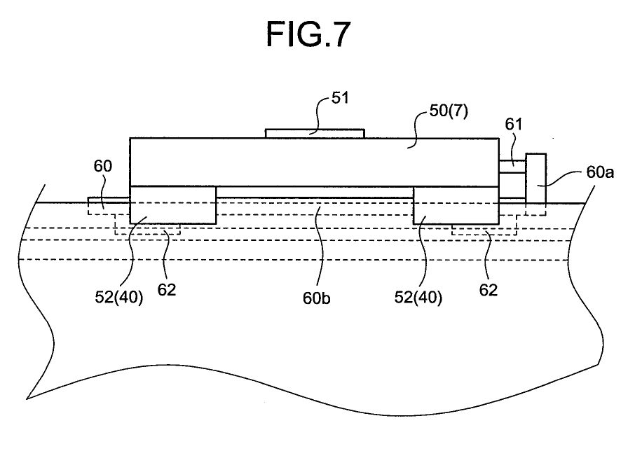

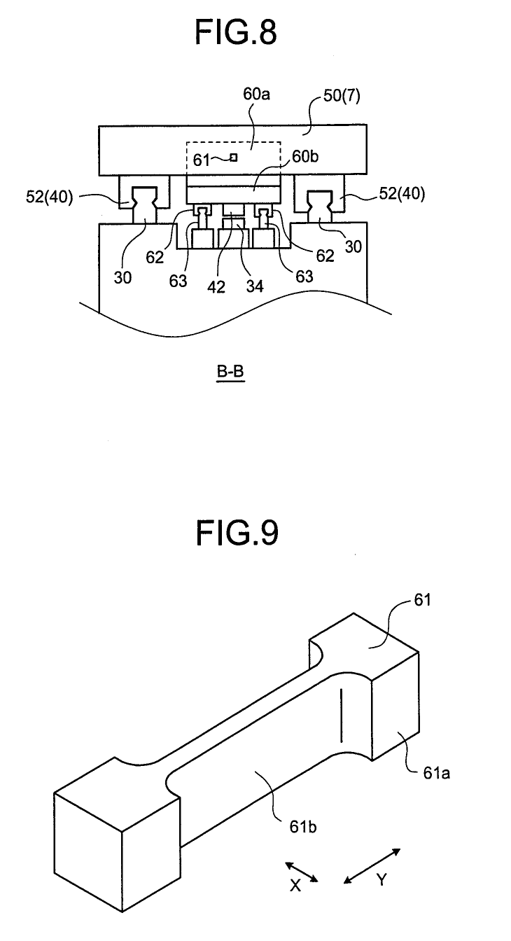

FIGS. 6 to 8 depict a configuration of a printing apparatus according to a second embodiment of the present invention. Specifically, FIG. 6 is a top view, FIG. 7 is a front view, and FIG. 8 is a B-B cross-section of FIG. 6. The second embodiment is the same as the first embodiment in that the block carriage 50 reciprocates on the rail 30 via the slider 52 or the track guiding member. The second embodiment is characterized such that the linear motor 42 or direct driving unit is not attached to the block carriage 50 on which the block 51 is mounted; however, the linear motor 42 is attached to the bottom of a conveyance carriage 60 combined to the block carriage 50 by a combining unit 61.

The conveyance carriage 60 in this example is arranged to reciprocate via the slider 62 on a rail 63 (used for the conveyance carriage 60) arranged in a groove of a mount. As shown in the drawings, the rail 63 is laid in parallel to the rail 30. Also, the conveyance carriage 60 is in a substantially L-lettered shape, and is configured by a portion 60b that covers the bottom of the block carriage 50 and a portion 60a that is erected approximately vertically until it reaches the same horizontal height as that of the block carriage 50. The combining unit 61 is configured by a member of which the center portion is thinned at least in the horizontal direction relative to the transportation direction (see FIG. 9).

In the second embodiment, for the driving unit of the block carriage 50, the linear motor 42 is used as an example. However, a rack-and-pinion, a ball screw and a nut, a wire drive or the like can also be used as the driving unit. Even when any means is adopted, if the driving unit is directly attached to the block carriage 50 as a drive target, the force is directly applied to the block carriage 50. Thus, generally, it is probable that the block carriage 50 is slightly deformed by the force. For example, when the driving unit is a linear motor, by the suction force caused due to the magnet 34 laid in the track direction, a carriage or a surface plate is distorted downwardly around the center where the linear motor 42 is located. Moreover, when the ball screw and the nut are the driving unit, it is probable that the carriage is deformed by the heat.

In the present invention, by the driving unit, instead of the block carriage 50, the conveyance carriage 60 carried thereon with the block carriage 50 receives force. When the combining unit 61 between the block carriage 50 and the conveyance carriage 60 is a rod-shaped member of which the center portion relative to the transported direction is thinned at least in the horizontal direction, the rigidity in a reciprocating transportation direction (Y direction in FIG. 9) can be increased than the rigidity in other directions except for the transportation direction (e.g., X direction in FIG. 9). That is, it is possible to transmit the force only in the transportation direction of the conveyance carriage 60 to the block carriage 50. Thus, the block carriage 50 will not directly receive the loading in the deforming direction that adversely affects the printing quality.

When the size of the thinned shape of the combining unit 61 is adjusted, the rigidity in the transportation direction can be increased than the rigidity of the slider 52 used for transporting the block carriage 50, and the rigidity in the X direction can be reduced than the rigidity of the slider 52. Accordingly, only the traction in the transportation direction obtained as a result of the linear motor 42 and the magnet 34 working together is transmitted to the block carriage 50. The motion (force) that results from the error in the track by the rail 63 in other directions (e.g., X direction of FIG. 9) and the slider 62 is absorbed by the deformation of the thinned portion, and not transmitted to the block carriage 50.

For example, in the above configuration, the conveyance carriage 60 slides or rolls on the rail 63 by the slider 62, and even when the rail 63 is sunk (that may result in the position error) by the movement of the conveyance carriage 60, the position error is not conveyed to the block carriage 50 because of the combining unit 61. Also, even when the straightness of the rail 63 is large, the position error, the position error caused thereby in the conveyance carriage 60 is not conveyed to the block carriage 50 by the deformation of the combining unit 61 itself. As a result, the block carriage 50 can be protected from a slight deformation caused by the driving unit. When not only the block carriage 50 but also the printing carriage 7 is configured completely the same, the operation and effect described above can be obtained. Thus, according to the printing apparatus, it becomes possible to improve the printing quality when the carriage carried thereon with the block 51 or the glass substrate 54 moves back and forth.

(First Modification)

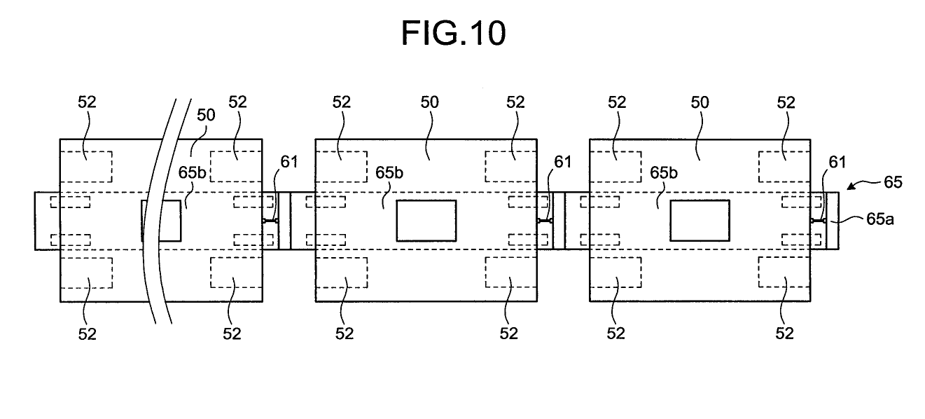

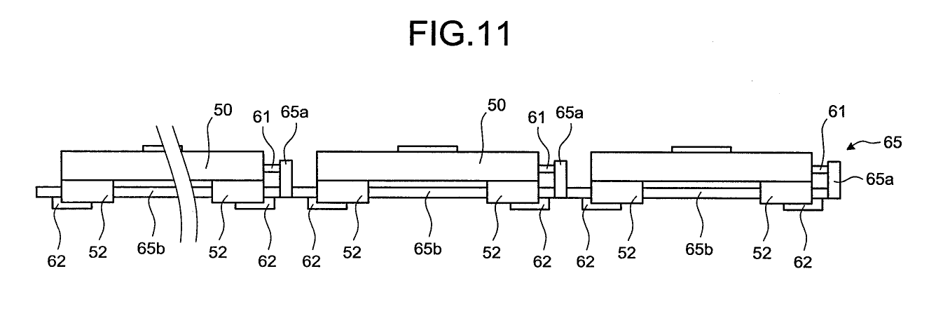

FIGS. 10 and 11 depict a first modification of the printing apparatus according to the second embodiment of the present invention. Specifically, FIG. 10 is a top view, and FIG. 11 is a front view. Also in the first modification, the block carriage 50 reciprocates on the rail (not shown) via the slider 52 as a track guiding member, which is the same as the second embodiment. Further, the first modification is the same as the second embodiment in that a conveyance carriage 65 is reciprocated by a unique slider 62, the conveyance carriage 65 is in a substantially L-lettered shape, and is configured by a portion 65b that covers the bottom of the block carriage 50 and a portion 65a that is erected approximately vertically until it reaches the same horizontal height as that of the block carriage 50, and the combining unit 61 is configured by a member of which the center portion is thinned relative to the transportation direction (see FIG. 9). The first modification is characterized such that one conveyance carriage 65 is combined to each of a plurality of block carriages 50 by the combining unit 61.

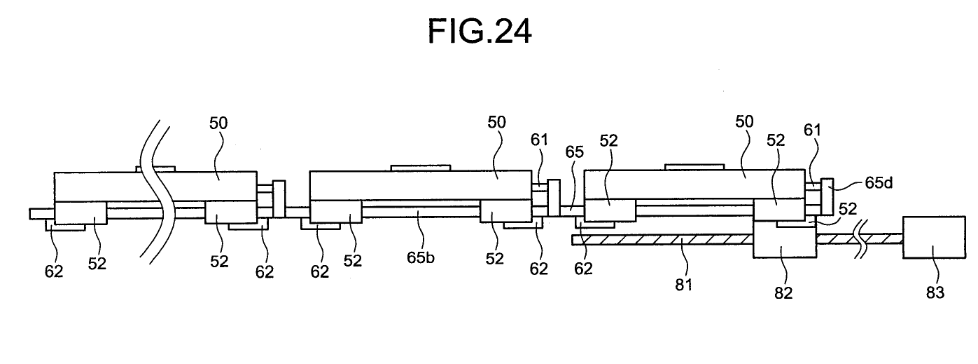

When the plurality of block carriages 50 are each combined to one conveyance carriage 65, there is no need of preparing a plurality of driving units, and thus the control also becomes simple. Moreover, the position errors of the conveyance carriages in the reciprocation are averaged, and thus the motion straightness as well as the printing accuracy are improved. When the mass of the conveyance carriage 65 is increased, the effect of suppressing a vibration can be improved. In this example, the conveyance carriage 65 is used in a mode in which the block carriages 50 are brought together. However, also the printing carriage can also be combined to the conveyance carriage 65. Even when this configuration is adopted, it is preferable because the number of driving units can be reduced and also the control becomes simple. The driving unit is not limited to a linear motor, and it can be configured as a ball screw 81, a nut 82, and a motor 83 as shown in FIG. 24 or it can be a wire drive and a rack-and-pinion.

(Second Modification)

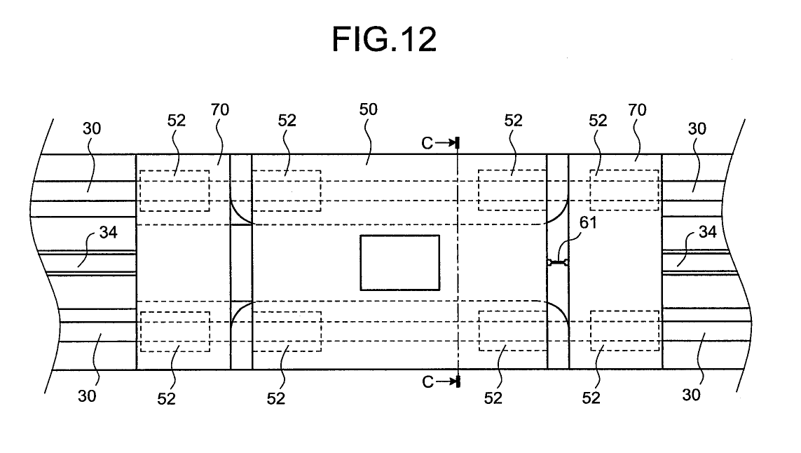

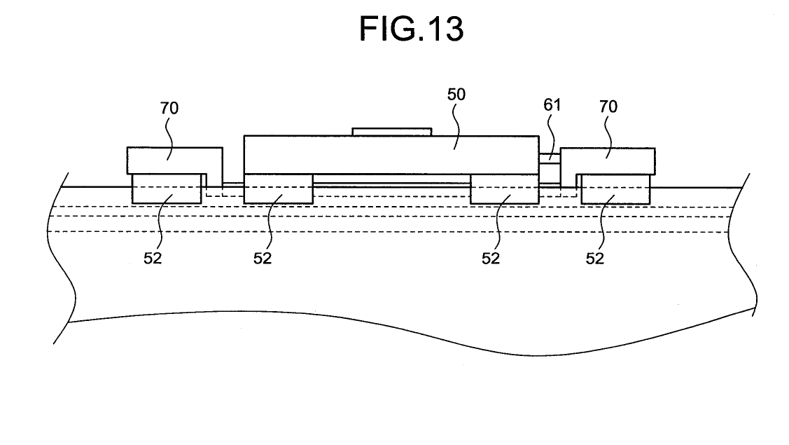

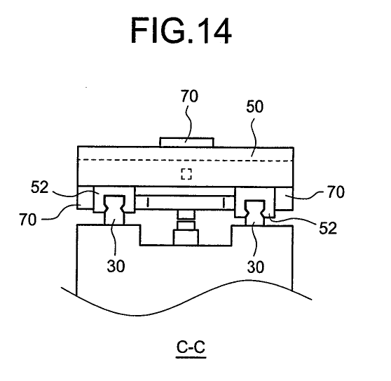

FIGS. 12 to 14 depict a second modification of the printing apparatus according to the second embodiment of the present invention. Specifically, FIG. 12 is a top view, FIG. 13 is a front view, and FIG. 14 is a C-C cross-section of FIG. 12. The second modification is the same as the second embodiment in that the block carriage 50 reciprocates on the rail 30 via the slider 52 as a track guiding member. The second modification is characterized such that a conveyance carriage 70 is so shaped to cover a portion (at the bottom of the block carriage 50) where there is no slider 52, and a gradually elevated portion besides the block carriage 50 reciprocates on the rail 30 of the block carriage 50 via the slider 52. The combining unit 61 between the block carriage 50 and the conveyance carriage 70 is configured by a rod-shaped member of which the center portion is thinned at least in the horizontal direction relative to the transportation direction (see FIG. 9), which is the same as the second embodiment.

As in the second embodiment, when a total of four rails, that is, the rails 30 (two) for the block carriage 50 and for the printing carriage, and rails 63 (two) for the conveyance carriage 60, are arranged (see FIGS. 6 and 8), it is probable that a time and trouble are required to adjust the straightness of each rail and the parallelism to the tracks to one another. To deal with this, when the rail for the conveyance carriage 70 is the same as the rails for the block carriage 50 and the printing carriage as in the second modification, there occurs an effect in that the time and trouble are reduced in half because the straightness and the parallelism can be adjusted only for the two rails. Similarly to the first modification, also the printing carriage can be combined to the conveyance carriage 70. Even when this configuration is adopted, it is preferable because the number of driving unit can be reduced and also the control becomes simple.

(Third Modification)

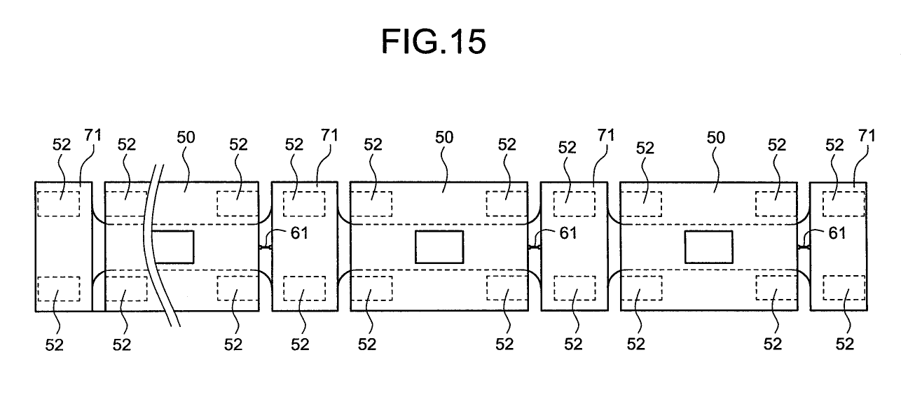

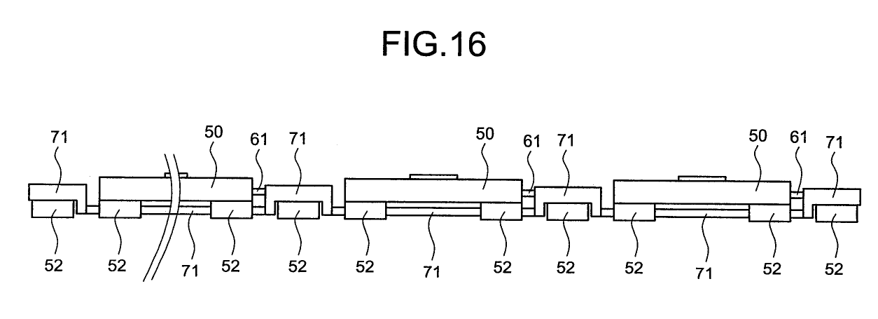

FIG. 15 and FIG. 16 depict a third modification of the printing apparatus according to the second embodiment of the present invention. Specifically, FIG. 15 is a top view and FIG. 16 is a front view. Also in the third modification, the block carriage 50 reciprocates on the rail (not shown) via the slider 52 as a track guiding member, which is the same as the second embodiment. The track of a conveyance carriage 71 is the same as that of the rail of the block carriage 50, which is the same as the second modification. In the third modification, one conveyance carriage 71 is combined to each of a plurality of block carriages 50 by the combining unit 61. The combining unit 61 is configured by a rod-shaped member of which the center portion relative to the transportation direction is thinned at least in the horizontal direction (see FIG. 9), which is the same as the second embodiment.

When the plurality of block carriages 50 are each combined to one conveyance carriage 71, there is no need of arranging a plurality of driving units, and also, the control of the driving unit becomes simple. Moreover, the position errors in the reciprocation are averaged, and thus the motion straightness as well as the printing accuracy are improved. When the mass of the conveyance carriage 71 is increased, the effect of suppressing a vibration can be also improved. Similarly to the first or second modification, also the printing carriage can be combined to the conveyance carriage 71. Even when this configuration is adopted, it is preferable because the number of driving units can be reduced and also the control becomes simple.

(Fourth Modification)

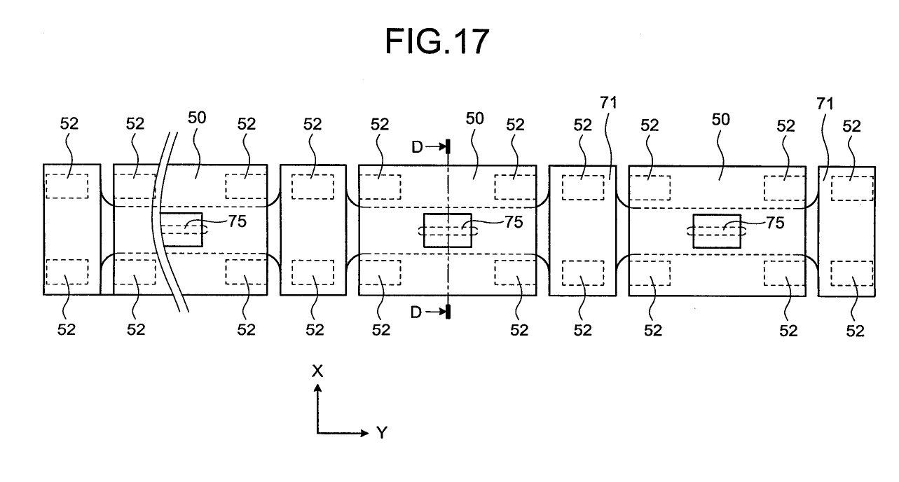

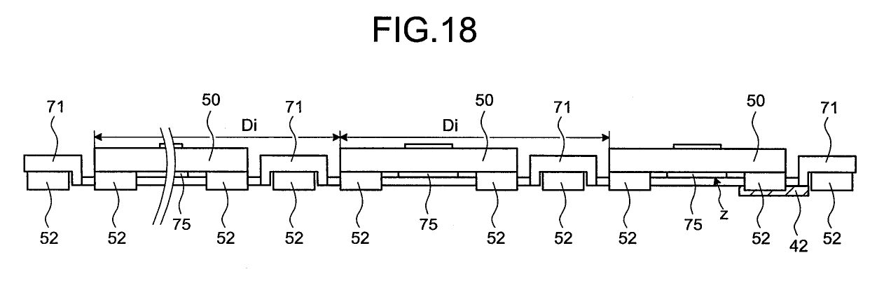

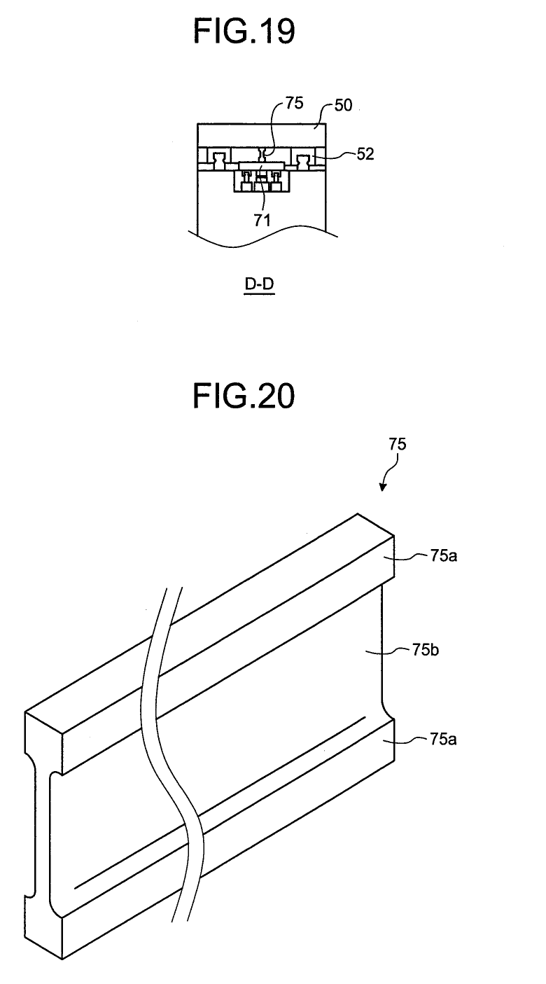

FIGS. 17 to 19 depict a fourth modification of the printing apparatus according to the second embodiment of the present invention. Specifically, FIG. 17 is a top view, FIG. 18 is a front view, and FIG. 19 is a D-D cross-section of FIG. 17. Also in the fourth modification, the block carriage 50 reciprocates on the rail (not shown) via the slider 52 as a track guiding member, the track of the conveyance carriage 71 is the same as that of the rail of the block carriage 50, and one conveyance carriage 71 is combined to a plurality of block carriages 50, which are the same as the third modification. The fourth modification is characterized by a combining unit 75. Specifically, the combining unit 75 is combined to the back bottom surface of the block carriage 50 from a bottom plate portion of the conveyance carriage 71. Moreover, the combining unit 75 is long in the transportation direction, and near the approximate center that is apart from ends 75a in the vertical direction, the combining unit 75 has a portion 75b that is thinned in the horizontal direction (see FIG. 20).

Even when the combining unit 75 is thus configured, the rigidity in the reciprocating transportation direction (Y direction of FIG. 17) can be increased than the rigidity in other directions except for the transportation direction (e.g., X direction of FIG. 17). Moreover, when the size of the thinned shape of the combining unit 75 is adjusted, the rigidity in other directions except for the transportation direction can be sufficiently reduced than the rigidity of the slider 52 as the track guiding member used for transportation of the block carriage 50.

With the configuration described above, with respect to the position of the carriage, the rail trajectory becomes more predominant than the force applied by the combining portion of the carriage. That is, only the traction in the transportation direction that is obtained as a result of the linear motor 42 and the magnet working together is transmitted to the block carriage 50, and the deforming force resulting from the track error by the rail and the slider in the other direction (e.g., Y direction of FIG. 17), which is absorbed as a result of the thinned portion itself being deformed, is not transmitted to the block carriage 50 any more. Effects obtained therefrom are a position variation between the carriages can be alleviated, and besides, friction between the rail and the slider 52 of the carriage becomes smaller, thereby alleviating abrasion of the member and also reducing the driving output. Note the completely same configuration can be applied not only to the block carriage 50 but also to the printing carriage 7. Accordingly, according to the printing apparatus, it becomes possible to improve the printing quality and printing accuracy when the carriage carried thereon with the block 51 and the glass substrate 54 moves back and forth.

In FIG. 18, a connecting portion between the linear motor 42 as a driving unit and the conveyance carriage 71 is located more externally in the transportation direction than a combining portion Z that is on the extreme end (in this case, the rightmost end). The driving unit, either of a contact type or a non-contact type, has a property to generate heat. This heat induces thermal expansion around the location where the conveyance carriage 71 is attached. Accordingly, the combining portion at the extreme end, out of the combining portion between the block carriage 50 or the like and the conveyance carriage 71, is placed to be spaced apart from the thermally expanded portion, and thereby only the end is affected by the thermal expansion. As a result, it becomes possible to suppress a phenomenon in which only a part of the block carriage among the combining portions is affected by the thermal expansion, thereby making a distance Di constant between the carriages. Thus, this will become advantageous for the control of the carriage. That is, when locating of the carriage at the extreme end is accurately determined, locating of the other carriages also is accurately determined. In a case of FIG. 18, when the linear sensor is set up at the left end of the block carriage 50, Di is not affected and only the middle block carriages are thermally extended. Thus, a reverse transfer location for the blanket cylinder is not deviated.

(Fifth Modification)

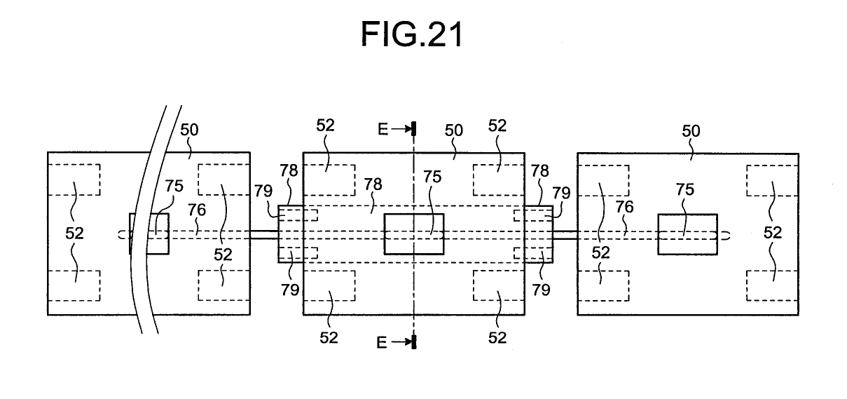

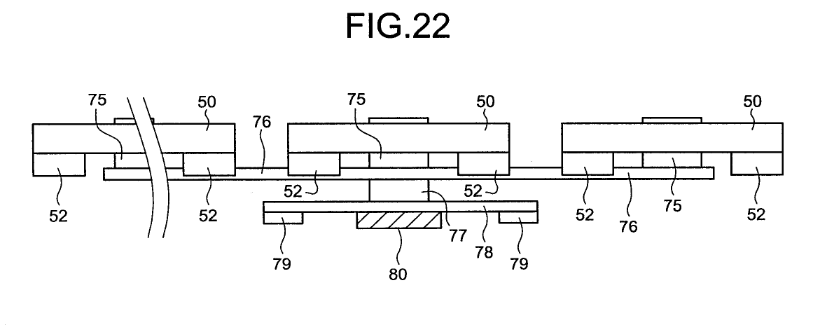

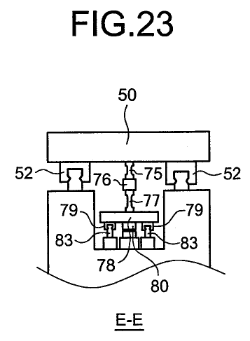

FIGS. 21 to 23 depict a fifth modification of the printing apparatus according to the second embodiment of the present invention. Specifically, FIG. 21 is a top view, FIG. 22 is a front view, and FIG. 23 is an E-E sectional view of FIG. 21. A basic configuration of the fifth modification is the same as that of the fourth modification. The fifth modification is characterized by the combining unit 75 and combining units 76 and 77. The combining unit 75 in the fourth modification is brought together by one long combining unit 76. A conveyance carriage 78 to which a linear motor 80 is attached is only one, and the conveyance carriage 78 is combined by the combining unit 76 and the combining unit 77. The block carriage 50 reciprocates on the rail (not shown) by the slider 52, which is the same as the second embodiment. Moreover, the conveyance carriage 78 reciprocates via a slider 79 on an independent rail 83.

Even with this configuration, when the combining units 75 and 77 between the block carriage 50 and the conveyance carriage 78 are members of which the center portion at least in the horizontal direction is thinned relative to the transported direction, the rigidity in the reciprocating transportation direction can be increased more than the rigidity in other directions except for the transportation direction, for example, a direction perpendicular to the transportation direction. Moreover, when the sizes of the thinned shape of the combining units 75 and 76 are adjusted, the rigidity in the transportation direction can be increased more than the rigidity of the slider 52 as a track guiding member used for transporting the block carriage 50. Accordingly, only the traction in the transportation direction obtained by the linear motor 42 as a result of working together with the magnet is transmitted to the block carriage 50, and the motion (force) resulting from the track error by the rail 83 and the slider 79 in other directions, for example, a direction perpendicular to the transportation direction, is absorbed as a result of the thinned portion being deformed, and thus that force is not transmitted to the block carriage 50. Consequently, the block carriage 50 can be protected from a slight deformation by the driving unit.

Moreover, when a plurality of block carriages 50 are each combined to one conveyance carriage 78, it is not necessary any more to arrange the driving unit as many as the number of block carriages 50, and thus the control of the driving unit also becomes simple. Moreover, when the configuration described above is adopted, the vertical direction of the combining unit can be lengthened, and thus the rigidity of the direction perpendicular to the transportation direction of the block carriage 50 can be easily reduced, thereby making it difficult to transmit the movement error in that direction to the block carriage 50. Similarly to the second or third modification, also the printing carriage can be combined to the conveyance carriage 78. Even with that configuration, the number of driving unit can be reduced and the control also becomes simple and therefore it is preferable.

### INDUSTRIAL APPLICABILITY

As described above, a printing apparatus and a position error suppressing method for the printing apparatus according to the present invention are useful for a printing apparatus relating to precision printing, and particularly suitable for manufacturing a printing apparatus that is hardly affected by the straightness or the parallelism of a track to maintain printing accuracy and also suitable for the use in a position error suppressing method for the printing apparatus.

1. A printing apparatus comprising:
a block carriage that supports a block surface plate having a block mounted thereon at a predetermined location and is reciprocated on a track by a first driving unit via a first track guiding member;
a printing carriage that supports a print surface plate having a substrate mounted thereon at a predetermined location and is reciprocated by a second driving unit via a second track guiding member on a same track as the track on which the block carriage is reciprocated;
a blanket cylinder that is pivotally supported to rotate at a predetermined location and on which a resin transition between the blanket cylinder and the block on the block carriage and a picture transfer between the blanket cylinder and the substrate on the printing carriage are alternately performed; and
a coating unit that applies a predetermined resin on a surface of the blanket cylinder, wherein
the first track guiding member and the second track guiding member are located in the block carriage and the printing carriage, respectively, to establish a same location relation, whereby the block and the substrate exchange the resin applied to the blanket cylinder at a same location on the track.

2. The printing apparatus according to claim 1, wherein the blanket cylinder is pivotally supported to rotate at a fixed location.

3. The printing apparatus according to claim 1, wherein the first driving unit and the second driving unit are linear motors.

4. The printing apparatus according to claim 1, wherein the block carriage is combined by a combining unit to a conveyance carriage that is reciprocated by the first driving unit, so that the block surface plate is transported reciprocably in a certain direction.

5. The printing apparatus according to claim 1, wherein the printing carriage is combined by a combining unit to a conveyance carriage that is reciprocated by the second driving unit, so that the print surface plate is transported reciprocably in a certain direction.

6. A printing apparatus comprising a block carriage that supports a block surface plate having a block mounted thereon at a predetermined location and is combined by a combining unit to a conveyance carriage that is reciprocated on a track by a driving unit.

7. A printing apparatus comprising a printing carriage that supports a print surface plate having a substrate mounted thereon at a predetermined location and is combined by a combining unit to a conveyance carriage that is reciprocated on a track by a driving unit.

8. The printing apparatus according to claim 4, wherein the block carriage or the printing carriage, and the conveyance carriage are combined by a combining unit in which a rigidity in a certain direction is larger than a rigidity of the track guiding members and a rigidity in other directions is smaller than the rigidity of the track guiding members.

9. The printing apparatus according to claim 4, wherein
the block carriage or the printing carriage, and the conveyance carriage are combined by the combining unit in which a rigidity in a certain direction is larger than a rigidity of the track guiding members and the rigidity in other directions is smaller than the rigidity of the track guiding members, and
the combining unit is a rod-shaped member of which a center portion relative to a transportation direction is thinned at least in a horizontal direction.

10. The printing apparatus according to claim 4, wherein the conveyance carriage reciprocates via a third track guiding member on a same track as the track on which the block carriage or the printing carriage reciprocates.

11. The printing apparatus according to claim 4, wherein the block carriage is arranged in plural to correspond to number of the blocks that become necessary for printing, and the plurality of block carriages are combined to one conveyance carriage and reciprocate in a certain direction.

12. The printing apparatus according to claim 4, wherein the block carriage and the printing carriage are combined to the conveyance carriage in common and reciprocate in a certain direction.

13. The printing apparatus according to claim 1, wherein the first driving unit and the second driving unit are linear motors.

14. The printing apparatus according to claim 4, wherein
the block carriage is arranged in plural to correspond to the number of the blocks that become necessary for printing,
the plurality of block carriages are combined to one conveyance carriage and reciprocate in a certain direction, and
a connecting portion between the first driving unit and the conveyance carriage is located in a transportation direction of the conveyance carriage more externally than a location of the combining unit at an extreme end on the conveyance carriage.

15. The printing apparatus according to claim 4, wherein
the block carriage and the printing carriage are combined to the conveyance carriage in common and reciprocate in a certain direction, and
a connecting portion between the first driving unit and the conveyance carriage is located in a transportation direction of the conveyance carriage more externally than a location of the combining unit at the extreme end on the conveyance carriage.

16. The printing apparatus according to claim 4, wherein
the first driving unit and the second driving unit are linear motors, and
a connecting portion between the first driving unit and the conveyance carriage is located in a transportation direction of the conveyance carriage more externally than a location of the combining unit at the extreme end on the conveyance carriage.

17. A position error suppressing method for a printing apparatus, the method comprising:
applying a predetermined resin by a coating unit on a surface of a blanket cylinder pivotally supported to rotate at a predetermined location on a mount;
causing a block carriage that is reciprocated by a first driving unit to move on a track via a first track guiding member to immediately below the blanket cylinder to bring a block supported at a predetermined location on a block surface plate on the block carriage into contact with the blanket cylinder, whereby a resin on the surface of the blanket cylinder is transitioned to the block;
after retracting the block carriage from immediately below the blanket cylinder on the track, causing a printing carriage that is reciprocated by a second driving unit via a second track guiding member, which is disposed to have a same positional relation as the first track guiding member, on the track to move to immediately below the blanket cylinder at a same location as that where the resin is transitioned to the block to bring a substrate that is supported at a predetermined location on a print surface plate on the printing carriage into contact with the blanket cylinder, whereby the resin left on the surface of the blanket cylinder is transferred in picture to the substrate.

18. A position error suppressing method for a printing apparatus, the method comprising:
applying a predetermined resin by a coating unit on a surface of a blanket cylinder pivotally supported to rotate at a predetermined location on a mount;
causing a block carriage that is reciprocated by a first driving unit to move on a track via a first track guiding member to immediately below the blanket cylinder to bring a block supported at a predetermined location on a block surface plate on the block carriage into contact with the blanket cylinder, whereby a resin on the surface of the blanket cylinder is transitioned to the block;
after retracting the block carriage from immediately below the blanket cylinder on the track, causing a printing carriage that is reciprocated by a second driving unit via a second track guiding member on the track to move to immediately below the blanket cylinder at a same location as that where the resin is transitioned to the block to bring a substrate that is supported at a predetermined location on a print surface plate on the printing carriage into contact with the blanket cylinder, whereby the resin left on the surface of the blanket cylinder is transferred in picture to the substrate, wherein
the driving unit of at least one of the block carriage or the printing carriage is attached to the conveyance carriage reciprocating on the track, and the conveyance carriage and the block carriage, or the conveyance carriage and the printing carriage, are combined by a combining unit.
